(19) United States
(12) Patent Application Publication
(10) Pub. No.: US 2015/0019548 A1
(43) Pub. Date: Jan. 15, 2015

(54) SYSTEM AND METHOD FOR AIDING A USER DECISION REGARDING TIME-SENSITIVE DATA ELEMENTS

(71) Applicants: Johannes BOHNENBERGER, Munchen (DE); Eugen POPP, Berg (DE)

(72) Inventors: Johannes BOHNENBERGER, Munchen (DE); Eugen POPP, Berg (DE)

(21) Appl. No.: 14/446,728

(22) Filed: Jul. 30, 2014

Related U.S. Application Data
(63) Continuation-in-part of application No. 13/939,689, filed on Jul. 11, 2013.

(51) Int. Cl. G06F 17/30; G06F 3/0484

(52) U.S. Cl. CPC G06F 17/30595; G06F 3/04842; G06F 17/30424
USPC 707/736

(57) ABSTRACT

Provided is a system and method for aiding a user in deciding upon an appropriate action to take regarding a plurality of time-sensitive data elements, the time-sensitive data elements stored in a first database, based upon stored further information data elements stored in a second database. The user is provided with a report which comprises links between the time-sensitive data elements and the stored further information data elements.

### FIELD OF THE INVENTION

The invention relates to the field of providing database information to a user, and more particularly, to providing links between information stored in several databases.

### BACKGROUND OF THE INVENTION

The storage of data, particularly in an electronic format, is becoming increasing popular. Due to this increase, more and more data elements are desired to be stored in various databases. Most databases are able to store large amounts of data; however, storage space in many situations can be a problem, particularly for small companies employing a limited size data storage system.

Therefore, in many cases, only particularly relevant data will be stored in a certain database; for example, a local database. In such an example, a user desiring to analyse the various data elements stored therein may not be provided with all the information necessary to analyse the data element for the specific task required.

Taking a specific example in the field of patents, a local database is provided (for example at a law office) and may be populated with data elements. These data elements will typically include a reference code, generally a number, which is representative of the patent document. For example, the reference code may include the patent number or patent application number. In addition, the data elements may also be provided with a time-sensitive element indicative of a certain deadline for a certain action. Typically, this will include a deadline or time limit associated with the payment of maintenance fees for the patent. Thus, a user inspecting the database may be provided with a number of data elements relating to a number of patents and the corresponding deadline.

A typical existing system will require an operator or worker, provided at the location of the local database, to alert the user of upcoming deadlines relating to the time-sensitive data elements by sending the user a message. Typically, in the interests of reduced data storage and transmission time, the message will be short in nature and only contain the directly relevant information, i.e., the time-sensitive data elements and associated time limit or deadline.

A user receiving this message will then be able to determine which time-sensitive data is important and which is not and respond accordingly. In terms of patents, because only directly relevant information is sent to the user, the user is forced to consult the patent document to determine if the patent is still relevant to the user's company or manufactured product. This, inevitably, takes time, particularly if the documents are not readily available and concern a number of different patents at different stages of prosecution or enforcement.

In patent document US 2007/0179956 A1, a system is proposed for the editing of the data elements stored in a database. A first database contains a plurality of data records wherein, in the specific example given, the data records are related to patent data. In this document, a user or client is able to update and edit the data records stored in the first database accordingly, thereby saving time of an operator (i.e., an operator or maintainer) of the first database.

In order to prevent the incorrect input of edited data to the first database, a second, verification database is provided. The verification database includes further information related to the data records. For instance, the verification data may include all foreign patents, divisional applications, or family members related to the patent (or data record) to be edited.

Therefore, when a user attempts to update the data record, the processor responsible for performing this action queries the verification database and verifies or matches a portion of the edited data with respect to the data stored in the verification database. This ensures that data is not edited for different or incorrect patents, and enables an unskilled user, or a user not familiar with the first database, to edit data records therein with confidence. A specific example regarding the payment of maintenance fees is disclosed in the document.

However, a problem exists in that the user may not be provided with all the information necessary to make an informed decision regarding the data record or patent. For example, the system of US 2007/0179956 A1 allows a user to edit the data record, but does not provide the user with information related to the patent—the user must acquire this information via alternative means.

Therefore, the present invention is presented so as to provide the user with additional information to aid the user in making an informed decision regarding the patent document, i.e., whether or not to pay the maintenance fee.

### SUMMARY OF THE INVENTION

The present invention provides a system for aiding a user in making an informed decision, the system comprising a first database, wherein the first database contains a data set and the data set includes at least one time-sensitive data element. The system also comprises a second database, wherein the second database comprises at least one second data set, the at least one second data set including at least one further information data element, and the system includes linking means adapted to produce a report, the report including one or more links between the at least one time-sensitive data element and a corresponding at least one further information data element from the at least one second data set, wherein the report is provided to the user.

A further embodiment includes the linking means adapted to search a third database, the third database comprising at least one user data set, the at least one user data set including at least one user data element, and wherein the report further includes indications of the at least one user data element.

Providing indications of additional data, i.e., data from the user side, enables a user to minimise their searching requirements as information that the user would otherwise have to locate is provided in the report.

Preferably, the indications of the at least one user data element includes one or more links between the at least one user data element and the at least one time-sensitive data element and/or the at least one further information data element.

In this way, a user may easily and quickly select or enter a link provided in the report in order to access the user data elements and associated information. This enables the transmission size of the report to be minimised, while still providing the user with minimal searching to be performed in order to make an informed decision.

In some further embodiments, the at least one user data element includes data related to at least one of: a priority setting, a product number, a product status, related applications/patents/trademarks, and a current use.

A further embodiment of the invention also comprises at least one reference code provided to the at least one of the time-sensitive data elements and the at least one of the further information data elements, the at least one reference code including, in particular, a priority date, and/or a filing data, and/or a registration number. The linking means, in this embodiment, is adapted to provide the one or more links by comparing and matching the at least one reference code of the at least one time-sensitive data element and the at least one reference code of the at least one further information data element.

Another embodiment provides the at least one user data element with at least one second reference code, and wherein the at least one time-sensitive data element is provided with the at least one second reference code. The linking means is adapted to provide the indications of the at least one user data element by comparing and matching the at least one second reference codes of the at least one time-sensitive data element and the at least one user data element.

Providing two reference codes enables the third database and the second database to be maintained independently of each other and with different reference codes related to the stored data elements, but enables the linking means to be able to identify links between the data elements. In this way, the user is afforded more flexibility when entering data into the third database. That is, the user does not require any knowledge of the reference code associated with the further information data element.

Another embodiment further specifies that the at least one further information data element comprises at least one of image data, text data, numeric data, and family data.

A further embodiment also includes message generation means, wherein the message generation means is adapted to provide a message to the user, preferably an electronic message, the message containing either the report produced by the linking means, or a reference to the report produced by the linking means.

An additional embodiment further includes a server, wherein the server is adapted to access the first database on the basis of an input, select the at least one time-sensitive data element according to the input, and provide data corresponding to the selected at least one time-sensitive data element to the linking means.

Preferably, the system above further comprises a trigger means, wherein the trigger means is adapted to generate a trigger on the basis of user instructions and time information, the user instructions specifying a time that the user should receive the report and wherein the trigger specifies a user identification code and a given time, wherein, when the server receives the trigger as the input, the server is adapted to access the first database and provide data corresponding to the at least one time-sensitive data element that falls within the given time to the linking means.

Another embodiment additionally provides an identification code wherein at least one of the at least one time-sensitive data elements is associated with the identification code, and wherein the report contains one or more links for the at least one time-sensitive data elements that correspond to the identification code.

Preferably, the system above also provides a graphical user interface, the graphical user interface adapted to receive the input, the input comprising the identification code, wherein the server is adapted to access the first database and retrieve the at least one time-sensitive data element corresponding to the identification code, display the at least one time-sensitive data element on the graphical user interface element, and provide data corresponding to the at least one time-sensitive data element to the linking means.

Another embodiment additionally comprises authentication means, wherein, upon receiving a request to access the at least one further information data element, the authentication means is adapted to verify, on the basis of obtained user credentials, if the request is generated by the intended user, and, if the request is verified, the authentication means is adapted to provide the at least one further information data element to the user.

A further embodiment further comprises order means, wherein the report further comprises at least one order link, each order link corresponding to one of the at least one time-sensitive data element, such that, when the order link is selected, the order means is adapted to generate a current order list.

The present invention also provides a method for aiding a user in making an informed decision, in particular by means of a system according to any one of those described above, the method comprising selecting at least one time-sensitive data element from a first database, the first database containing a data set, the data set including the at least one time-sensitive data element. Additionally, the method comprises linking at least one of the at least one time-sensitive data elements and a corresponding at least one further information data element, and reporting, in the form of a report, one or more links between the at least one time-sensitive data element and the corresponding further information data element. Further, the method includes providing the report to the user.

A further embodiment of the method includes linking at least one user data element from a third database with the at least one time-sensitive data element and/or the further information data element, the third database comprising at least one user data set, the at least one user data set including the at least one user data element, and wherein the report includes indications of the at least one user data element.

Preferably, the indications of the at least one user data element includes one or more links between the at least one user data element and the at least one time-sensitive data element and/or the at least one further information data element.

In some embodiments, the at least one user data element includes data related to at least one of: a priority setting, a product number, a product status, related applications/patents/trademarks, and a current use.

A further embodiment of the method of the invention also comprises at least one reference code provided to the at least one of the time-sensitive data elements and the at least one of the further information data elements, the at least one reference code including, in particular, a priority date, and/or a filing data, and/or a registration number, and wherein the linking includes matching the at least one reference code of the at least one of the at least one time-sensitive data element with the at least one reference code of the at least one of the at least one further information data element.

Yet another embodiment of the method provides the at least one user data element with at least one second reference code, and wherein the at least one time-sensitive data element is provided with the at least one second reference code. The report includes the one or more links between the at least one user data element and the at least one time-sensitive data element by comparing and matching the at least one second reference codes of the at least one time-sensitive data element and the at least one user data element.

A further embodiment of the method also includes generating a message, preferably an electronic message, the message containing either the report produced by the linking means, or a reference to the report produced by the linking means.

A further embodiment of the method of the invention further comprises receiving a request to access the at least one further information data element, obtaining user credentials, verifying if the obtained user credentials match stored user credentials, and providing the at least one further information data element to the user if the obtained user credentials match the stored user credentials.

The present invention also comprises a computer readable device having instructions for implementing the method according to any one of those discussed above when being executed.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilised, and the accompanying drawings of which:

FIG. 1 shows an exemplary configuration of a system adapted to aid a user in making an informed decision regarding at least one time-sensitive data element.

FIG. 2 shows a simplified exemplary graphical user interface provided to an operator of the system of FIG. 1.

FIG. 3 shows a simplified exemplary message sent to the user of the system of FIG. 1.

FIG. 4 shows an exemplary method for using the system of FIG. 1.

FIG. 5 shows an alternative exemplary configuration of a system adapted to aid a user in making an informed decision regarding at least one time-sensitive data element including a third database.

### DETAIL DESCRIPTION OF THE INVENTION

The following description provides a working example of the present invention. In the description, the term “user” is used to refer to a client or the like, while the term “operator” is used to refer to an operator or maintainer of a specific system. For example, in terms of patents or trademarks, the operator may be a worker at a law firm, while the user may be the corresponding client or owner of a patent, patent application, or trademark, respectively.

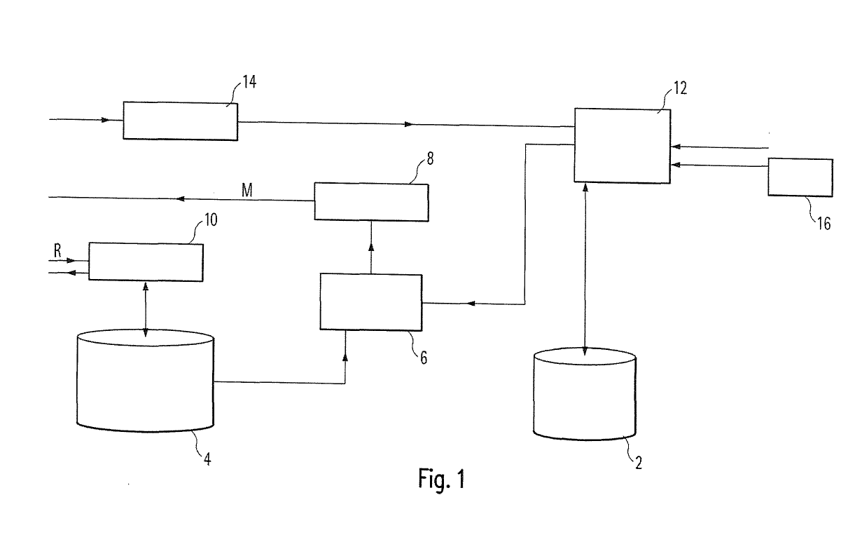

FIG. 1 shows one possible configuration of the present invention. A first database 2 is provided and contains a first data set which may be populated with at least one data element. In particular, the data elements are time-sensitive data elements which are representative of certain actions that must be performed relative to a certain time limit or deadline. For instance, the time-sensitive data elements may be indicative of a maintenance fee to be paid for a certain patent, patent application, or trademark, for example.

The time-sensitive data elements may also be provided with one or more reference codes; for example, a specific number or the like. This reference code does not have to be identical to the patent number or trademark serial or registration number in the case of patents and trademarks, but in one embodiment is identical to these numbers. Indeed, the reference code may simply be a randomly assigned number. For example, a time-sensitive data element may be assigned to be number 001, 002, etc. depending upon the order that it was entered into the first database 2.

A second database 4 is also provided. This second database 4 contains at least one further data set which comprises at least one further information data element. The further information data element typically contains data that is related to the time-sensitive data element, but not stored in the first database 2. For example, the further information element may include picture or image data related to the time-sensitive data element. In the case of patents, this could include the drawings of the patent document. Alternatively, or in addition, the further information data element may include text or number based data. In some cases, the further information data elements may include family data. In the context of patents, this may include family members associated with the patent, patent application, or trademark related to the time-sensitive data element.

The second database 4 may be a public database or may be a database maintained by the user or operator, i.e., a private database. In either case, the further information data element may be provided with a similar or identical reference code. In this way, the further information data element and the time-sensitive data element can be related via the one or more reference codes wherein, in a preferred arrangement, the reference code of one further information data element and one time-sensitive data element are the same.

In a preferred arrangement, the second database 4 is a publically available database, such as Espacenet or the USPTO Pairs. These databases typically comprise the majority of relevant information related to a patent document or trademark, provided the patent document or trademark information is made available to the public, that a user may require in order to make an informed decision. In one arrangement, the reference code is preferably the patent number or application number of the patent document. Alternatively, the reference code may be a trademark serial number or trademark registration number. This, of course, is readily available in the second database 4 and thus allows for minimal effort in order to provide a correspondence between the further information element and the time-sensitive data element.

Alternatively, the second database 4 may be a private database that is located either at the user side or the operator side of the system. The private database may include only specific information, such as the image or text data. For example, the further information data element may be the drawings associated with a patent document only, or the image of the trademark. Equally, other data sets may be provided that contain other aspects of the patent document or trademark information. For example, a third data set may contain further information data elements indicative of the claims of a patent document or the owner's information of a trademark. In this case, the reference codes of the second and third data sets are set to be the same. In a further embodiment, the further information data elements may include patent family members associated with the patent, patent application, or trademark related to the time-sensitive data element.

As is also shown in FIG. 1, a linking means 6 is provided. The linking means 6 is adapted to produce a report. The report may generally be a table or arrangement that shows, essentially, a link between the time-sensitive data element stored in the first database 2 and the further information data element stored in the second database 4.

The report may be of any construction and may include any information therein. Preferably, the report contains the link and some form of identification related to the time-sensitive information. For example, the report may comprise the reference code associated with one time-sensitive data element accompanied by the corresponding link to the further information data element. In some cases, multiple links may be provided. For example, if a third data set containing a different set of further information data elements is provided, then the report may comprise two or more separate links; one link to the further information data element of the second data set, and a second link to the further information data element of the third data set. Alternatively, or in addition, a number of separate links to the patent family documents may be provided in the report, if appropriate. In this way, a user may select one of the corresponding links to view an associated patent document. Preferably, an indication of the patent family document, i.e., a patent number, patent application number, etc., is provided in the report.

In operation, the linking means 6 is able to search the second database 4 on the basis of an optional input and determine the link(s) between the time-sensitive data element and the further information data element(s). Once the report has been generated, the report is provided to the user such that the user may make an informed decision regarding the time-sensitive data element.

In one example, the linking means 6 searches the second database 4 on the basis of the reference code of the time-sensitive data element and determines the link by matching the reference code to the corresponding reference code of the further information data element. Any known searching and matching technique may be applied, and such techniques may vary depending upon the type of reference code used. When the reference code is number based, one exemplary link may be determined simply by matching the numbers of the two or more elements accordingly.

One possible matching method may be to use the Hamming distance when analysing the corresponding reference codes. The Hamming distance essentially compares each element of a string of data, in this case the reference codes, and identifies the similarities or differences regarding the characters of the string therebetween. That is, the Hamming distance is effectively a measure of the minimum number of substitutions required to change one string to the other, or the minimum number of errors that could have transformed the string.

As an example, a first string may be a patent number or registration number of 1 111 112. The corresponding reference code of a further information data element, in this example, may be 1 112 112. Thus, the Hamming distance in this case is 1, wherein the fourth entry of the string is different between the two reference codes. Equally, a third code may be 2 222 221. Here the Hamming distance is 7 with regards to the first data string; all the entries in the string are different.

Using the Hamming distance effectively provides a rating regarding the correspondence between a time-sensitive data element and a further information data element. By using such a matching scheme, a “best match” further information data element may be provided as the link in the report for each time-sensitive data element. This enables an appropriate link to be provided in the report. In this case, the linking means 6 is adapted to search and subsequently calculate the Hamming distance for all further information data elements in the second database 4.

In a preferred embodiment, the link is provided in a descending order according to the Hamming distance. That is, if the Hamming distance for a further information data element and a time-sensitive information element is 0, i.e., each entry in the data string corresponds, then the link is provided on the report between the corresponding data elements. If, however, the Hamming distance is 1, then potentially a number of links could be provided—there could be a plurality of further information data elements that have a Hamming distance of 1.

In such a case, two options may be provided. One option could be to provide all the links to all the further information data elements having a Hamming distance of 1 in the report. In this case, if no further information data element has a Hamming distance of 0, then all the links to further information data elements having a Hamming distance of 1 may be displayed on the report. It is then the task of the user to select the appropriate link of the plurality of links on the report that corresponds to the time-sensitive data element. That is, several of the links provided will not correspond to the time-sensitive information and thus must be manually filtered by the user.

In an alternative and preferred embodiment, the linking means 6 may be adapted to search on the basis of a second reference code. For example, the time-sensitive data element may be provided with a patent number or registration number and a priority date (and/or filing date). In this case, the linking means 6 may search and establish a link on the basis of both reference codes.

In this case, if the Hamming distance for the first reference code is 0 between a further information data element and time-sensitive data element, then no further searching is necessary. However, a secondary check may be performed even if this is the case, wherein the secondary check calculates the Hamming distance between the second reference codes. This may act as a confirmation that the correct link is found or act as a fail-safe in case of typing errors associated with the reference codes, for example. If, however, a Hamming distance of 0 is not found for the first reference code, the linking means 6 may search the further information data elements with the next lowest Hamming distance coefficient with the second reference code.

That is, the further information data elements determined to have a Hamming distance of 1 on the basis of the first reference code (patent number or trademark serial/registration number) are then searched on the basis of the second reference code (e.g., priority date). If the priority date matches between the further information data element and the time-sensitive data element, i.e., the Hamming distance of the second reference code is 0, then the corresponding link is provided in the report.

It is likely that only one of the further information data elements will satisfy this criterion, but this may not necessarily be the case. Thus, one or more of the further information elements may have a Hamming distance of 1 for the first reference code and 0 for the second reference code and thus also be displayed on the report; the user may then select the appropriate link manually. Alternatively, the linking means 6 may be adapted to search on the basis of a third reference code. Thus, if one or more further information data elements have a Hamming distance of 1 for the first reference code and a Hamming distance of 0 for the second reference code, a third reference code may be used to further identify the further information data elements. Of course, this may be applied to any number of reference codes and used in any order until the correct further information data element is found or a “best match” further information data element(s).

To limit the search, each reference code may be associated with a limit for the Hamming distance. For example, the first reference code, the patent number or trademark serial/registration number, may be limited to a Hamming distance of 2 or less. That is, the further information data elements are selected sequentially on the basis of the Hamming distance from a Hamming distance of 0 to 2. Any further information data element with a Hamming distance of 3 or more is ignored, in this example. Equally, the second reference code, the priority date, may also be limited to a Hamming distance of 1 or less. Thus, a further information data element is also ignored if the Hamming distance is less than 2 for the first reference code but greater than 1 for the second reference code. Any limitations may be appropriately selected depending upon the specific criteria for performing a match.

The above described method enables rapid and accurate searching, and thus the provision of selectable links according to a plurality of criteria. In this method, each additional search is restricted to the results of the previous search, i.e., the further information data elements found according to the Hamming distance of the first reference code. This means that each search is performed on a sub-set of the data set and thus means that processing time is quicker.

In some embodiments, this may not be desired, and the linking means 6 may search the entire data set, and calculate Hamming distances according to all the reference codes. In such a situation, the “best match” further information data element may be found by summing the Hamming distances of each reference code. However, to avoid erroneous results, certain Hamming distances may be given a weighting. For example, the first Hamming distance may correspond to a patent number and be given a lower weighting than the second Hamming distance corresponding to a priority date, for example. As an example, suppose the results of the first and second Hamming distances are 1, 2 and 2, 1 for two different further information data elements. In this case, the summation is the same, but a weighting may be applied to the second of the two Hamming distances. Assume, for example, that this is a weighting of 1:2; that is, the first Hamming distance is weighted by one, while the second Hamming distance is weighted by two. Thus, the summation of the first data element is 1×1+2×2=5, while for the second data element is 2×1+1×2=4. In this case, the priority date correlation is stronger than the patent number (or for trademarks, the filing date correlation is stronger than the serial/registration number), and thus a link to the second further information data element is provided in the report. The specific weighting may vary depending upon the exact criteria that the user or operator desires to use in order to determine a “best match”.

As seen in FIG. 1, a server 12 may also be provided to the system. The server 12 essentially acts as an interface between the operator and the first database 2. The server 12 may be adapted to receive the optional input discussed above. As will be explained in more detail below, the optional input may be a number of possible types of input depending upon the operator's or user's desires.

One option is that the system further comprises trigger means 16, which communicates with the sever 12. The trigger means 16 may supply a trigger to the server 12, as the input, which initiates the searching of the first database 2. The trigger is, preferably, provided on the basis of time information and user specified information. In this regard, the trigger may be generated and supplied intermittently to the server 12. Upon receiving the trigger, the server 12 may be adapted to check the first database 2 to identify which time-sensitive data elements have deadlines that fall within a certain given time; the given time may also be specified by the user and correspond to a desired time range.

The trigger is therefore generated on the basis of time information and the user specified instructions. In other words, the trigger means 16 is provided with access to a clock and the user's instructions. The user's instructions may specify when the user wishes to receive a report. For example, the user may wish to receive the report every month, quarterly, or annually. When the clock indicates a time, or time period, corresponding to the user's instructions, the trigger is generated and sent to the server 12. The trigger may also comprise an indication of the user, such as a user identification code (user ID). When the server 12 receives the trigger from the trigger means 16, the server 12 begins searching the first database 2 according to the user ID.

The given time may be a predefined time limit, which may or may not also be specified by the user. For example, the given time may be one month, two months, or more. On the basis of the trigger, the server 12 checks the time-sensitive data elements in the first database 2, and any time-sensitive data element that has a deadline of less than the given time, e.g., one month, is selected. The selected time-sensitive data elements may then be sent to the linking means 6, or preferably data indicative of the time-sensitive data elements (the reference code, for example), wherein the linking means 6 performs a search of the second database 4 as described above.

In such an arrangement, the user instruction's and given time may be identical. This means that a user requests a report every month, for example, and all the time-sensitive data elements that fall within the given time are selected and used in the report. That is, a user may request a report on the first of every month, for example, January 1^{st}. Thus, the given time, in this example, corresponds to one month after January 1^{st}, i.e., February 1^{st}. Thus, any time-sensitive data element with a deadline falling before February 1^{st},i.e., within the given time, is selected. In this case, the given time is calculated from the generation of the report and, in the above example, would correspond to one month period starting from the generation of the trigger. Of course, this need not be the case, and a given time may be two months. Preferably, however, the given time is not less than the user's instructions to avoid time-sensitive data elements not appearing in the reports.

Equally, each user may specify a different given or predefined time, and the reports may be generated on the basis of these different given times. For example, the user specified instructions may also detail the specific given time that the user wishes for time-sensitive data elements to be displayed. A first user may wish to receive a report every two months, but have time-sensitive data elements with a deadline up to six months after the trigger signal, i.e., the effective date that the user will receive the report. In contrast, a second user may wish to receive a report every month, and have time-sensitive data elements with a deadline up to three months after the trigger signal, for example. The trigger signal may include an indication of the user specified given time such that the server 12 may search the first database 2 accordingly.

The advantage of providing only the trigger means 16 is that the system described above can, effectively, be automatically controlled on the operator side, thus reducing the time spent monitoring or generating messages and the like. The operator merely has to insert the user instructions into the trigger means 16 or server 12. When the reports are generated, messaging means 8 may be adapted to automatically send a message M to the respective users, as will be discussed below.

In some situations, a fully automatic system is not desired. In an alternative configuration, the server 12 is adapted to display a graphical user interface 20 to the operator. The graphical user interface 20 may comprise any number of inputs and outputs, and may be custom designed according to the operator's desires.

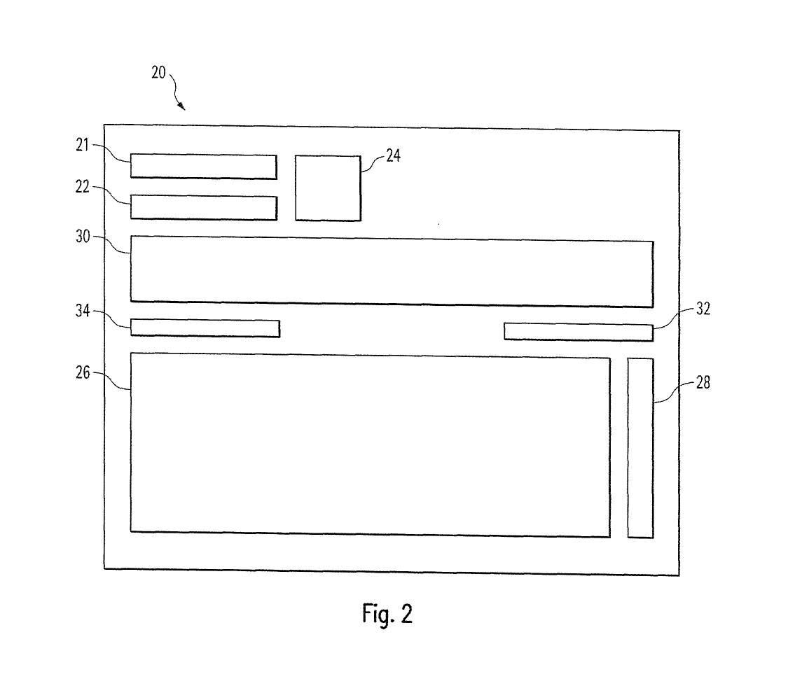

An exemplary graphical user interface 20 is shown in FIG. 2. The graphical user interface 20 comprises an input means 21, 22 which is adapted to receive the optional input discussed above. The input means 21, 22 may be adapted to receive any type of data depending upon the exact configuration of the system. In FIG. 2, two optional input means 21, 22 are disclosed. The operator has the option of inputting the user identification code (user ID) in user ID input box 21, or a patent number in patent number box 22. This allows for the operator to search either by the patent number or by the user's ID. The user's ID may be equivalent to the reference code discussed above, but preferably this is not the case. In a preferred embodiment, the user's ID is a unique identification code that is specific to each user, but may cover a number of time-sensitive data elements. That is, a plurality of time-sensitive data elements related to the user may be assigned the same user ID.

The graphical user interface 20 of FIG. 2 also includes editing means 24, which allows the operator to edit any of the information stored within the first database 2. When the user ID or patent/trademark number is inserted, a list of patents and/or trademarks is displayed in box 26. Preferably, the reference code and the time-sensitive data element are displayed, along with the corresponding deadline. In this way, an operator can identify which time-sensitive elements are important for each user based upon the indentified deadline. Box 26 may also comprise a tick box 28 which allows an operator to select which time-sensitive data elements and associated deadlines should be sent to the user; although, preferably, the system is automatic, as described above, and thus does not require this feature. Additionally, user instructions may also be displayed in box 30, wherein the user instructions may comprise a written instruction detailing the given time discussed above, as well as additional information. For example, a user may only wish to receive information regarding maintenance payments and no other deadlines; such instructions are presented such that the operator may select the time-sensitive elements on the basis of this information via the tick box 28. Alternatively, these instructions are stored in the server 12 or trigger means 16 and thus the automatic search of the first database 2 yields the time-sensitive data elements according to the user's instructions.

When the appropriate time-sensitive data elements have been selected, the operator may select generate message box 32. As discussed briefly above, data indicative of the selected time-sensitive data elements (e.g., the reference code) is sent to the linking means 6 when the generate message box 32 is selected. From here, the linking means 6 determines the corresponding links to the further information data elements, and the report is generated as previously described.

Alternatively, both the trigger means 16 and the graphical user interface 20 may be provided. In this case, the system may be configured to operate in the automatic or non-automatic mode. A selection box 34 may be provided on the graphical user interface 20 such that the operator may choose which option is applicable for the specific user. In this system, the report is generated automatically but may be supervised by the operator via monitoring of the graphical user interface 20.

Referring back to FIG. 1, in order to provide the user with the report, one of two options may be utilised. Generally, a message M may be sent to the user via messaging means 8. The message M may contain either the report in its entirety or a reference to the report. In the latter case, the report is typically provided digitally and, in a preferred arrangement, is a webpage or the like. Therefore, a user receives a message M with a certain reference thereon, and when the reference is selected or input to a web browser, the report webpage is displayed.

The message M itself may be either electronic or physical in nature. An electronic message may, for example, include an email or the like. Thus, the message M is simply provided to the user via electronic means, i.e., wired cables, a LAN, or the internet, etc., and displayed at a corresponding user display screen or the like. As discussed above, the message M may comprise the report including the corresponding links to the elements of the second database 4, such as hyperlinks, or may include a written text link such that the user may manually input the link into a browser or such. Alternatively, the message M may comprise a reference to the report webpage—in this case, it may be desirable to provide only one reference (hyperlink or written link) to the report webpage.

In contrast, a physical message may be generated by the messaging means 8. The physical message may include a message M provided on a solid object, and is preferably provided on one or more pieces of paper. As with the electronically generated message, the physical message may include corresponding written links to the elements of the second database 4, whereby the user may manually input the link into a browser or such. Alternatively, the message M may comprise a written link to the report webpage, wherein the report webpage is provided in an electronic format.

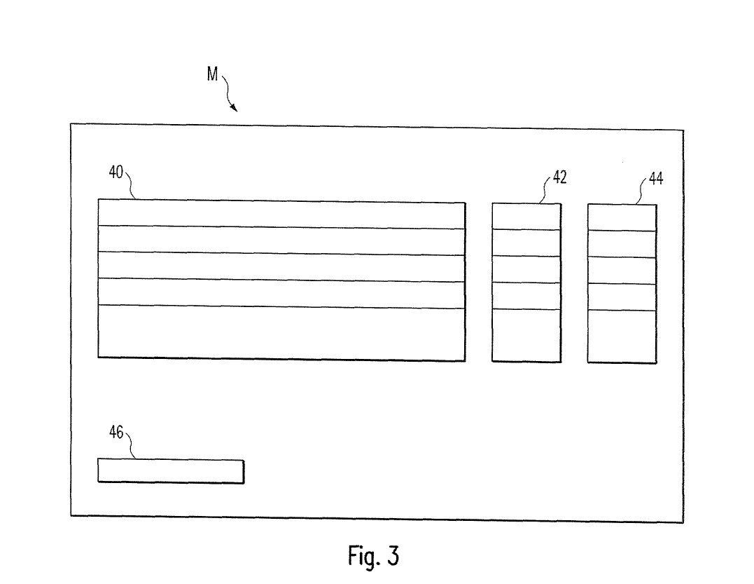

An exemplary message M is shown in FIG. 3. The message M of FIG. 3 comprises the report in its entirety as discussed above. The message M may include a list of corresponding patents, trademarks, or time-sensitive data elements, generally given by box 40. Associated with each time-sensitive data element is a corresponding link 42. The link 42, as described above, may be a hyperlink or a written link. Upon selecting or entering the link 42, the corresponding further information data element is displayed to the user. In the preferred case, this will include directing the user to the webpage corresponding to the further information data element of the second database 4, i.e., the Espacnet webpage.

In FIG. 3, the message M may also be provided with corresponding action links 44. The action links 44 may comprise any number of actions. In a preferred arrangement, the action links 44 comprise an “Add to List”, “Abandon”, and “Ignore” action. The “Add to List” action will be described below. The “Abandon” and “Ignore” actions, when selected, may transmit a return message back to the operator informing the operator that the user no longer wishes to maintain the patent or be reminded of the deadline respectively. Accordingly, the first database 2 may be updated via the server 12 when the return message is received. In one example, this may mean removing the time-sensitive data element from the first database 2 or placing the time-sensitive data element into a separate database. When either of the “Abandon” or “Ignore” actions are selected, the user may be presented with a confirmation for confirming the action prior to the return message being sent.

An alternative configuration of the message M may be to provide a message M that simply includes a link to the report. In this case, the report may be similar to the message M of FIG. 3 in layout and construction, but as described above, is provided as a webpage or the like. Therefore, the message M may simply include a link that, when the user selects or enters the link into a web browser, the user is directed to the report. The same or similar actions may be performed on the report webpage as is discussed in relation to the message M of FIG. 3.

As seen in FIG. 1, an order means 14 may also be provided to the system, which is adapted to collect information from the user regarding the payment of the associated fees. Generally the report may be provided with a number of time-sensitive data elements, many of which will require payment of maintenance fees and the like. Each time-sensitive data element may be provided with the “Add to List” action link 44 or an order action link 44 and when the user selects the “Add to List” action link 44, an order message is sent to the order means 14.

The order means 14 may then accumulate the order messages for each time-sensitive data element when the user selects the corresponding “Add to List” action link 44. When the user has selected all the time-sensitive data elements and corresponding action links 44, the user may request to pay the entire order by selecting, for example, a “Confirm Order” action link. When this action link is selected, a further message may be sent to the order means 14 and the order means 14 provides the user with a complete order list and corresponding total payment required. The order list may be interactive and include a tick box for each item in the order list corresponding to the selected time-sensitive data elements. When items are removed or added, the interactive list may be updated, by the order means 14, to provide a running total cost.

Alternatively, the order means 14 provides a current order list to the user each time an “Add to List” action link 44 is selected, wherein the order list is updated on the basis of the user interaction. In this case, the order list includes the selected time-sensitive data elements and corresponding running total cost. In this case, the report and order list may be provided simultaneously to the user. This may include, when the message M is an electronic message, providing the message M as an interactive message including the report and order list. Thus, when any action, such as selecting the “Add to list” action link 44, is performed, the order means 14 is adapted to update the message M.

When the order list is confirmed, the user may select to pay the order via a “Complete Order” action link. Here, a message may be generated and sent to payment means. The payment means may be any kind of payment means. In some embodiments, the payment means may be external to the system and be operated by an external source. For example, when selecting the “Complete Order” action link, the user may simply be taken to a corresponding payment or transaction website, where the operator's details are already pre-inserted. Thus, the user may pay the outstanding fee with relative ease. After the payment is complete, a message may be sent from the payment means to the server 12, and the first database 2 is updated accordingly.

In a preferred arrangement, the payment means forms part of the server 12, or is a further function of the server 12. This way, the operator may be able to monitor directly the transactions, wherein the payment means is a privately controlled means. For example, the payment means may be an input for receiving the user's payment information and confirmation of payment/order. The server 12 may receive and forward this information so as to pay the fee via an external service.

Further, the system may be provided with an authentication means 10. The authentication means 10 is adapted to verify that the user attempting to access the further information data elements is the intended user. This is particularly useful with regards to when the second database 4 is a private database, or when the report generated by linking means 6 is also publically accessible.

The authentication means 10 may operate in a number of ways. Firstly, in the message M, a password 46 may be provided. This password 46 may be a one-time password 46 and may only be used for the links 42 on the message M sent to the user, or to enable the user to access the report webpage when a link is selected from the message M to the report webpage (when the message M contains a link to the report webpage). Alternatively, the password 46 may be pre-assigned to the user such that the same user must input the same password 46 with regards to multiple messages M or report webpages. In this configuration, when the link 42 or the link to the report webpage is selected or input to a web browser, a password input is displayed to the user. When the password 46 is input, a request R is transmitted to the authentication means 10. The authentication means 10 is then adapted to compare the request R with an expected request or stored credentials stored in the authentication means 10, wherein the stored credentials may comprise the corresponding password 46 or information related thereto. If the request R matches the stored credentials, then the authentication means 10 may either retrieve the further information data element from the second database 4, or it may simply allow for the user to access the further information data elements directly from the second database 4.

In a second configuration, when the link 42 or the link to the report webpage is selected or input to a web browser, the request R is transmitted to the authentication means 10, whereby the request R contains some user credentials. The credentials may comprise, for example, a user ID or similar information. In one configuration, the credentials may comprise an IP address of the computer attempting to access the further information data element. In this regard, the authentication means 10 may comprise a number of acceptable stored credentials for a plurality of users, such that any user of the system may be able to access their own data, but not the data of a third-party. Indeed, the authentication means 10 may be programmed via the operator using the server 12. If the request R matches one or all of the stored user credentials, then the authentication means 10 may either retrieve the further information data element from the second database 4, or it may simply allow for the user to access the further information data elements directly from the second database 4.

In both scenarios, if the request R does not match the expected request or user credentials, then the further information data element is not displayed. The authentication means 10 may operate in accordance with any message M type, i.e., electronic or physical.

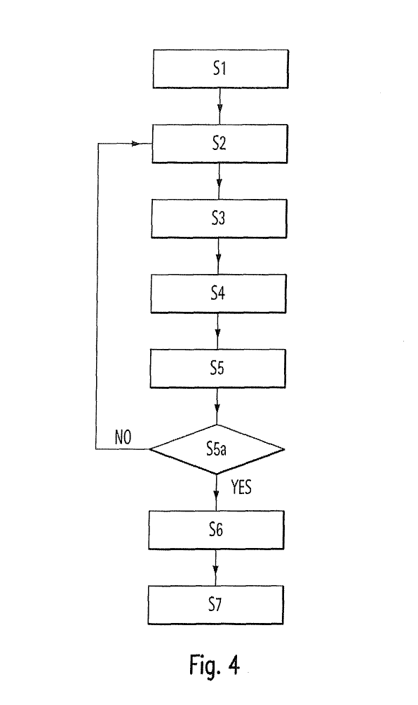

FIG. 4 describes one possible method for the use of the system described above. At step S1, an optional input is received. As discussed above, the input may be one or both of the trigger provided by the trigger means 16, or the user ID or reference code provided by the operator. Typically, the server 12 receives the input via the graphical user interface 20 or directly from the trigger means 16. When the input is received, the server 12 checks the time-sensitive data elements stored in the first database 2, step S2, and retrieves these elements based upon the input. This may include retrieving a specific time-sensitive data element or reference code thereof, or may include retrieving a plurality of time-sensitive data elements in accordance with one or more reference codes. Alternatively, this may include retrieving a plurality of time-sensitive data elements that fall within a given time. As discussed in relation to FIG. 2, the operator may manipulate the selected time-sensitive data elements via the graphical user interface 20 and select which elements will comprise the report to be provided to the user.

Each time-sensitive data element may be associated with a reference code and data, typically including this reference code, may be sent to the linking means 6, step S3. The linking means 6 is then adapted to check the second database 4 on the basis of the data or reference code, step S4. In essence, the linking means 6 may search sequentially through the further information data elements stored in the second database 4 using any of the matching techniques described above, e.g., the Hamming distance. Such a searching technique may be categorised depending upon the reference code. For example, the second database 4 may be arranged such that all reference codes beginning with EP or US are stored in different locations.

When a match is provided between the reference code of the time-sensitive data element and the reference code of the further information data element, the linking means 6 stores the corresponding link, step S5. In this case, the link may include a database address, i.e., the entry of the further information element within the second database 4, or the link may be the web address if the second database 4 is public.

The method may also include an optional step 5a. Each of the selected time-sensitive data elements may be assigned a number, n. Thus, the linking means 6 searches, at step S2, the n-th data element. The corresponding link is then stored at step S5 and the linking means 6 is adapted to search the n-th+1 data element. That is, step S5a checks if the number n of the time-sensitive data elements is equal to the total number of selected time-sensitive data elements N provided by the server 12. If NO, the method proceeds back to step S2 and the first database is searched on the basis of the next time-sensitive data element. If YES at step S5a, the method proceeds to step S6. Additionally, if no link is found at step S5, a “No further information available” message may be stored instead of the link in the linking means 6. This is described further below.

Once the searching is complete and all selected time-sensitive data elements have been searched, the linking means 6 generates a report, step S6. As discussed above, the report may be a table or the like including all the necessary information. From here, the messaging means 8 is activated and generates a message M, which is sent to the user. The message M may, of course, take the form of any of the message forms discussed above.

Once the user has received the message M, the system is in a state of responsiveness and may wait for at least one of the request R, return message, and payment message. Upon receiving the request R, return message, or at least one order message, the system performs the necessary actions as described above. Primarily, however, the first database 2 is updated once the user performs an action.

If no action is performed, the system may update the user instructions accordingly. For example, the user instructions may be to generate a report every month. If no action is received two weeks after sending the message M, for example, the system may update the user instructions to specify the generating of a report every week. In this way, a further message is sent prior to the expiration of the deadline. Alternatively, when the operator operates the server 12, an alert may be generated stating that the request R, return message, or order message has not yet been received. Using the graphical user interface 20, the operator may generate a specific message M directed to the user detailing the specific urgent time-sensitive data element.

Although the abovementioned arrangement has been described with the components as separate components, the arrangement is not limited to such. Indeed, in one configuration, the server 12 may include the linking means 6. Additionally, the server 12 may also include the message generation means 8, the trigger means 16, and the authentication means 10. Generally, however, the first and second databases 2, 4 are provided as separate entities, although this does not have to be the case.

Generally, when time-sensitive data elements are limited to the patent or trademark field, a corresponding further information element is available. However, this may not always be the case. In such an arrangement, when the linking means 6 tries to find a match between the reference code of the time-sensitive data element and the reference code of the further information element, no match can be found; for example, when a document is not yet publically available. In such a case, the report may be provided as described above, but instead of presenting the link, the report may comprise a “No further information available” message in place of the link. In this way, the user is still informed of an impending deadline, but is also informed that no further information is available. Thus, the user must look elsewhere to make an informed decision.

Indeed, this is also applicable for the Hamming distances discussed above, when such a method is used to identify a “best match”. In some situations, the “best match” may still, and potentially obviously, be the incorrect further information data element. Using the limited Hamming distances with respect to each reference code above, should none of the further information elements satisfy the criteria, then the report may also comprise the “No further information available” message in place of the link.

A further arrangement may provide different further information data elements depending upon the user requirements or the type of time-sensitive data element. For example, when responding to a maintenance fee payment request, the user may wish to only see the drawings of the patent—this will enable the user to immediately identify if the patent is relevant to a currently manufactured product, for example. However, if the time-sensitive data element relates to a response to an Office Action, for example, then the user may wish to see a copy of the Office Action in addition to the drawings and description. Thus, the linking means 6 may also be adapted to select which links to provide in the report depending upon a user specification or the type of time-sensitive data element.

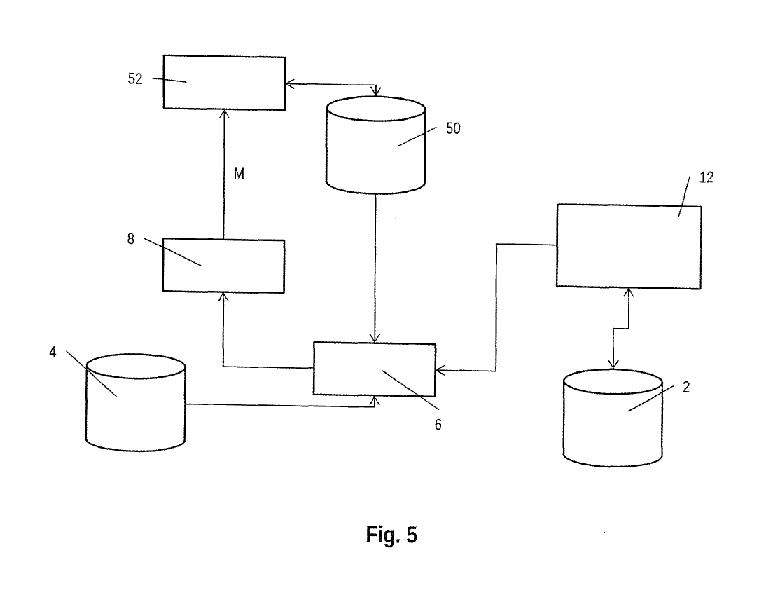

FIG. 5 shows a further, alternative embodiment. In FIG. 5, a third database 50 is provided. Although not limited, the third database 50 may be provided at a user's side; in other words, the third database 50 may be a database maintained and populated by a user. Alternatively, the third database 50 may be provided at the operator's side but a user may be permitted access to store, change, or maintain data elements stored therein. In such a configuration, the second database 4 is preferably a public database such as Espacenet or USPTO Pairs, as discussed above. In a similar manner to that described above, the first database 2 is also provided.

In the aforementioned configuration, the first database 2 stores time-sensitive data elements in addition to a reference code. Likewise, the second database 4 stores further information data elements that may be related to the time-sensitive data elements via the reference code, wherein the linking means 6 is adapted to provide a link between the two via matching of the reference codes of two corresponding data elements.

In this embodiment, the third database 50 is provided with a user data set that includes several user data elements. The user data elements may be any data elements related to the user and/or the company that the user is employed by. More importantly, the user data elements may be linked to the time-sensitive data elements and/or the further information data elements.

In this regard, the user data elements may include the reference code(s) used to link the further information data elements and the time-sensitive data elements. In such an arrangement, the reference codes are the same (or within a Hamming distance tolerance) for all three of the data elements that correspond. In the field of patents, the reference code may be a patent or patent application number that is stored with all three types of data elements in the respective databases.

In some further embodiments, the reference codes used to link the time-sensitive data elements with the further information data elements may be different to the reference codes used to link the time-sensitive data elements with the user data elements. For example, the reference code used to link the time-sensitive data elements with the further information data elements may be a patent number, patent application number, trademark registration, or the like, while the reference codes used to link the time-sensitive data elements with the user data elements may be a user reference number, i.e., MBP-001. In such a situation, the first database 2 may store both sets of reference codes, and subsequently transmit both codes to the linking means 6.

In one embodiment, the term “different” means different with regards to being outside the Hamming distance or the pre-set requirements for the Hamming distance. Suppose, for example, that the code MBP-001 is used as the user reference number and the patent number 2 111 111 is used to link the time-sensitive data elements with the user data elements. Comparing the Hamming distances above, assuming that MBP-001 is a seven-digit code, yields a Hamming distance of 6—the final digit is the same in both codes. Now, assuming the Hamming distance requirement is set to 1, the exemplary codes given above are outside of the Hamming distance requirements and are thus different. In other words, the reference codes do not Wave to be identical and may have some flexibility to compensate for typing errors or storage/transmission errors, but are preferably different within the context stated above.

The user data elements may include any number of data elements. In a preferred arrangement, the user data elements are stored in the third database 50 in conjunction with the user reference number or reference code. In addition, a priority status may also be assigned to each of the user data elements. The priority status may indicate an assigned priority depending upon how important the user views the particular data element. In the case of patents, this could be an indication of how relevant the patent is to the user or how important the patent is in terms of a product or commercially. The priority status may be set as HIGH indicating a relatively higher priority data element, MED indicating a medium priority data element, or LOW indicating a relatively lower priority data element. Additional or alternative schemes may be employed to indicate the priority, e.g., a number scale from 1 to 5.

In addition, or alternatively, the user data elements may include a product number and/or a product status, where appropriate. In this case, the product number could be a number or identification code that directly relates to a product or products that are manufactured or handled by the user. Moreover, a product status may indicate the current status of the product(s) that relate to the time-sensitive data element. For example, suppose a patent relates to two products, X and Y, in that the technology used in products X and Y is covered by the patent. The reference code may then be stored in conjunction with an indication of product X and product Y. Moreover, the product status could indicate that product X is discontinued, while product Y is a new, currently produced product.

In some embodiments, a “current use” status may be stored as the user data elements in addition to or alternatively to the priority status, product status, and/or product number. The current use status may indicate what the item associated with the time-sensitive data element is used for. For example, the item may be a patent that covers a currently manufacture product. Alternatively, the item may be a patent that is licensed to an external company. The current use status may therefore indicate the exact use, i.e., “current product” or “licensed to . . . ”, or may simply indicate that the item is used “internally” or “externally”. Equally, the item may not be currently in use and may have a “none” status assigned.

Additionally, the user data elements may also include an indication of related patent applications, patents, and/or trademarks, i.e., patent family members. As discussed previously, this information may be stored as the further information data elements in the second database 4.

In the above embodiment, the linking means 6 is adapted to generate the report, and messaging means 8 is adapted to generate the message M on the basis of the report, wherein the report includes one or more links between the time-sensitive data element and the further information data element in addition to an indication of the user data element(s). In a preferred embodiment, the report includes only the links between the time-sensitive data element(s) and the further information data element(s), but includes a reproduction of the user data element(s). For example, the report may include the box 40, link 42, and action links 44 of FIG. 3, in addition to a table indicating, for example, the priority status, the product number, the product status, and/or related data. In this way, a message M may provide the user with more information in order to make an informed decision. For example, if a product related to the time-sensitive data element is discontinued, the user may decide not to pay any maintenance fees. Therefore, the user is provided with more information in one location, thus aiding the user's decision.

Alternatively, the report may be provided with the one or more links between the time-sensitive data element(s) and the further information data element(s) in addition to one or more links between the time-sensitive data element(s) and the user data element(s). In this regard, the message M may be provided with another set of links 42, i.e., two or more columns of links 42 in FIG. 3, such that a user may select either link in order to access the desired information. Such a configuration reduces the amount of information in one location and/or the amount of information to be transmitted, but still allows the user to access the data if required. Alternatively, the one or more links may be between the time-sensitive data element(s) and the further information data element(s) in addition to one or more links between the further information data element(s) and the user data element(s), depending upon the preferred configuration.

In operation, the linking means 6 is able to search the third database 50 on the basis of the optional input and determine the link(s) between the time-sensitive data element and the user data element(s), in much the same way with regards to the second database 4. In one example, the linking means 6 searches the third database 50 on the basis of the reference code of the time-sensitive data element and determines the link by matching the reference code to the corresponding reference code of the user data element. Any known searching and matching technique may be applied, such as the Hamming distance, and such techniques may vary depending upon the type of reference code used.

Alternatively, when the one or more links between the further information data element(s) and the user data element(s) are employed, the linking means 6 may be adapted to search the second database 4 first and then on the basis of the obtained further information data elements, search the third database 50. This means that the reference codes used may be the same between the further information data elements and the user data elements.

In this embodiment, the report is generated and includes data from at least three databases. In much the same way as discussed above, the report is provided to the user such that the user may make an informed decision regarding the time-sensitive data element(s). However, in this embodiment, additional data related to the user's own data is provided, thereby minimising the effort required by the user to locate relevant information. For example, rather than the user receiving the message M and then having to manually search through the third database 50, the message contains the relevant information or links such that user may simply read off or access the relevant information via the message M.

Although not shown in FIG. 5, the system may also be provided with the server 12, the trigger means 16, authentication means 10, and order means 14 as shown in FIG. 1. The operation of these components is similar to that described above. In addition, a server 52 may optionally be provided to allow the user to access the third database 50, via a user interface, in order to edit any of the user data elements stored in the third database 50, e.g., to update the priority or product status. In some embodiments, a second authentication means may be provided that acts between the linking means 6 and the third database 50. The purpose of this second authentication means may be to identify that an appropriate operator and/or linking means 6 is attempting to access the third database 50. This may be particularly useful when the third database 50 is provided in a different location to the first database 2.

Thus, the above described system and various configurations are provided to aid a user in deciding upon an appropriate action to take regarding a plurality of time-sensitive data elements, while also minimising the storage space required for more relevant data elements.

1. A system for aiding a user in making an informed decision, the system comprising:
a first database, the first database containing a data set, the data set including at least one time-sensitive data element;
a second database, the second database comprising at least one second data set, the at least one second data set including at least one further information data element; and
linking means adapted to produce a report, the report including one or more links between the at least one time-sensitive data element and a corresponding at least one further information data element from the at least one second data set, wherein the report is provided to the user.

2. The system of claim 1, wherein the linking means is adapted to search a third database, the third database comprising at least one user data set, the at least one user data set including at least one user data element, and wherein the report further includes indications of the at least one user data element.

3. The system of claim 2, wherein the indications of the at least one user data element includes one or more links between the at least one user data element and the at least one time-sensitive data element and/or the at least one further information data element.

4. The system of claim 2, wherein the at least one user data element includes data related to at least one of: a priority setting, a product number, a product status, related applications/patents/trademarks, and a current use.

5. The system of claim 1, wherein at least one of the time-sensitive data elements and at least one of the further information data elements are provided with at least one reference code, in particular a patent or trademark priority date, and/or a patent or trademark filing data, and/or a patent or trademark registration number, and/or a trademark serial number, and wherein the linking means is adapted to provide the one or more links by comparing and matching the at least one reference code of the at least one time-sensitive data element and the at least one reference code of the at least one further information data element.

6. The system of claim 2, wherein the at least one user data element is provided with at least one second reference code, the at least one time-sensitive data element is provided with the at least one second reference code, and wherein the linking means is adapted to provide the indications of the at least one user data element by comparing and matching the at least one second reference codes of the at least one time-sensitive data element and the at least one user data element.

7. The system of claim 1, further comprising a server, wherein the server is adapted to access the first database on the basis of an input, select the at least one time-sensitive data element according to the input, and provide data corresponding to the selected at least one time-sensitive data element to the linking means.

8. The system of claim 7, further comprising a trigger means, wherein the trigger means is adapted to generate a trigger on the basis of user instructions and time information, the user instructions specifying a time that the user should receive the report and wherein the trigger specifies a given time, wherein, when the server receives the trigger, the server is adapted to access the first database and provide data to the linking means corresponding to the at least one time-sensitive data element that falls within the given time.

9. The system of claim 1, further comprising order means, wherein the report further comprises at least one order link, the at least one order link corresponds to at least one of the at least one time-sensitive data element, such that, when the at least one order link is selected, the order means is adapted to generate a current order list.

10. The system of claim 1, wherein the at least one further information data element comprises at least one of image data, text data, numeric data, and family data.

11. The system of claim 1, further comprising message generation means, the message generation means adapted to provide a message (M) to the user, the message (M) containing either:
the report produced by the linking means; or
a reference to the report produced by the linking means.

12. The system of claim 11, wherein the message (M) is an electronic message (M).

13. The system of claims 7, wherein at least one of the at least one time-sensitive data elements is associated with an identification code, and wherein the report contains one or more links for the at least one time-sensitive data elements that correspond to the identification code.

14. The system of claim 13, wherein the server is adapted to provide a graphical user interface, the graphical user interface adapted to receive the input, the input comprising the identification code, wherein the server is adapted to access the first database and retrieve the at least one time-sensitive data element corresponding to the identification code, display the at least one time-sensitive data element on the graphical user interface element, and provide data corresponding to the at least one time-sensitive data element to the linking means.

15. The system of claim 1, further comprising authentication means, wherein, upon receiving a request (R) to access the at least one further information data element, the authentication means is adapted to verify, on the basis of obtained user credentials, if the request (R) is generated by the intended user, and, if the request is verified, the authentication means is adapted to provide the at least one further information data element to the user.

16. A method for aiding a user in making an informed decision, in particular by means of a system according to claim 1, the method comprising:
selecting at least one time-sensitive data element from a first database, the first database containing a data set, the data set including the at least one time-sensitive data element;
linking at least one of the at least one time-sensitive data elements and a corresponding at least one further information data element;
reporting, in the form of a report, one or more links between the at least one time-sensitive data element and the corresponding further information data element; and
providing the report to the user.

17. The method of claim 16, wherein the linking further includes linking at least one user data element from a third database with the at least one time-sensitive data element and/or the further information data element, the third database comprising at least one user data set, the at least one user data set including the at least one user data element, and wherein the report includes indications of the at least one user data element.

18. The method of claim 17, wherein the indications of the at least one user data element includes one or more links between the at least one user data element and the at least one time-sensitive data element and/or the at least one further information data element.

19. The system of claim 18, wherein the at least one user data element includes data related to at least one of: a priority setting, a product number, a product status, related applications/patents/trademarks, and a current use.

20. The method of claim 16, wherein at least one of the at least one time-sensitive data elements and at least one of the at least one further information data elements are provided with at least one reference code, in particular a patent or trademark priority date, and/or a patent or trademark filing data, and/or a patent or trademark registration number, and/or a trademark serial number, and wherein the linking step includes matching the at least one reference code of the at least one of the at least one time-sensitive data element with the at least one reference code of the at least one of the at least one further information data element.

21. The system of claim 17, wherein the at least one user data element is provided with at least one second reference code, the at least one time-sensitive data element is provided with the at least one second reference code, and wherein the report includes the one or more links between the at least one user data element and the at least one time-sensitive data element by comparing and matching the at least one second reference codes of the at least one time-sensitive data element and the at least one user data element.

22. The method of claim 16, further comprising generating a message (M), to be provided to the user, the message (M) containing either:
the report; or
a reference to the report.

23. The method of claim 22, wherein the message (M) is an electronic message (M).

24. The method of claim 16, further comprising;
receiving a request (R) to access the at least one further information data element;
obtaining user credentials;
verifying if the obtained user credentials match stored user credentials; and
providing the at least one further information data element to the user if the obtained user credentials match the stored user credentials.

25. A computer readable device having instructions for implementing the method according to claim 16 when being executed.
